(19) United States
(12) Patent Application Publication
(10) Pub. No.: US 2025/0371979 A1
(43) Pub. Date: Dec. 4, 2025

(54) DRIVING ASSISTANCE DEVICE, VEHICLE, CONTROL METHOD FOR DRIVING ASSISTANCE DEVICE, AND STORAGE MEDIUM

(71) Applicant: HONDA MOTOR CO., LTD., Tokyo (JP)

(72) Inventors: Misako KOIKE, Wako-shi (JP); Kosuke NAKANISHI, Wako-shi (JP); Gakuyo FUJIMOTO, Wako-shi (JP)

(21) Appl. No.: 19/219,633

(22) Filed: May 27, 2025

(30) Foreign Application Priority Data
May 30, 2024 (JP) 2024-088234

(51) Int. Cl. G08G 1/16; G06T 7/70; G06V 20/56

(52) U.S. Cl. CPC G08G 1/166; G06T 7/70; G06V 20/56; G06T 2207/30201; G06T 2207/30268; G06V 2201/07

(57) ABSTRACT

A driving assistance device comprises a detection unit configured to detect a plurality of notification objects as targets for a notification to a driver of a vehicle on the basis of surrounding information of the vehicle; an estimation unit configured to estimate a line-of-sight direction of the driver; a grouping unit configured to group a first notification object and one or more second notification objects within a predetermined range from the first notification object, as one group in a case where the driver has visually checked the first notification object among the plurality of notification objects on the basis of the line-of-sight direction; and a suppression unit configured to suppress the notification regarding the one group.

### CROSS-REFERENCE TO RELATED APPLICATION(S)

This application claims priority to and the benefit of Japanese Patent Application No. 2024-088234, filed on May 30, 2024, the entire disclosure of which is incorporated herein by reference.

### BACKGROUND OF THE INVENTION

### Field of the Invention

The present invention relates to a driving assistance device, a vehicle, a control method of a driving assistance device, and a storage medium.

### Description of the Related Art

Japanese Patent No. 6419401 discloses that a line-of-sight direction of a driver detected by a line-of-sight direction detection unit 103 is compared with a required viewing direction determined by a required viewing direction determination unit 110, a direction not including the line-of sight direction among the required viewing directions is determined as an overlooked direction, and a notification is issued.

However, in the technique disclosed in Japanese Patent No. 6419401, in a crowded situation such as waiting for a traffic light at an intersection, even in a case where one pedestrian is seen, other pedestrians around the pedestrian are not seen. Therefore, there is a problem that even though a group of pedestrians is recognized as a crowd, excessive notifications are performed.

### SUMMARY OF THE INVENTION

The present invention has been made in view of the above problems, and provides a technique for suppressing excessive notifications to a driver.

According to one aspect of the present invention, there is provided a driving assistance device comprising: a detection unit configured to detect a plurality of notification objects as targets for a notification to a driver of a vehicle on the basis of surrounding information of the vehicle; an estimation unit configured to estimate a line-of-sight direction of the driver; a first control unit configured to control a first visual confirmation flag to turn ON in a case where the driver has visually checked a first notification object among the plurality of notification objects on the basis of the line-of-sight direction, the first visual confirmation flag indicating whether or not the driver has visually checked the first notification object; a second control unit configured to control a first recognition flag to turn ON in a case where the first visual confirmation flag is turned ON, the first recognition flag indicating whether or not the driver has recognized the first notification object; a third control unit configured to control a second recognition flag to turn ON in response to the first recognition flag being turned ON in a case where a second notification object among the plurality of notification objects is within a predetermined range from the first notification object, the second recognition flag indicating whether or not the driver has recognized the second notification object; a grouping unit configured to group the first notification object and the second notification object, for each of which the recognition flag is turned ON, as one group; and a suppression unit configured to suppress the notification regarding the one group.

### BRIEF DESCRIPTION OF THE DRAWINGS

FIG. 1 is a block diagram of a vehicle and a control device according to an embodiment;

FIGS. 2A and 2B are a flowchart illustrating a procedure of processing executed by a driving assistance device according to an embodiment;

FIG. 3 is an explanatory diagram of a situation of a plurality of notification objects according to an embodiment;

FIG. 4 is an explanatory diagram of a notification condition at the time of right turn and left turn of a vehicle according to an embodiment;

FIG. 5 is an explanatory diagram of a notification condition in a case where a preceding vehicle is present in front of a vehicle according to an embodiment;

FIG. 6 is an explanatory diagram of a notification condition in a case where a pedestrian enters a predetermined area in front of a vehicle according to an embodiment;

FIG. 7 is an explanatory diagram of a situation of a plurality of notification objects according to a first modification example;

FIG. 8 is an explanatory view of a predetermined range set in a two-wheeled vehicle according to a second modification example; and

FIG. 9 is an explanatory diagram of a situation of a plurality of notification objects according to a third modification example.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Control Device and Application Example Thereof

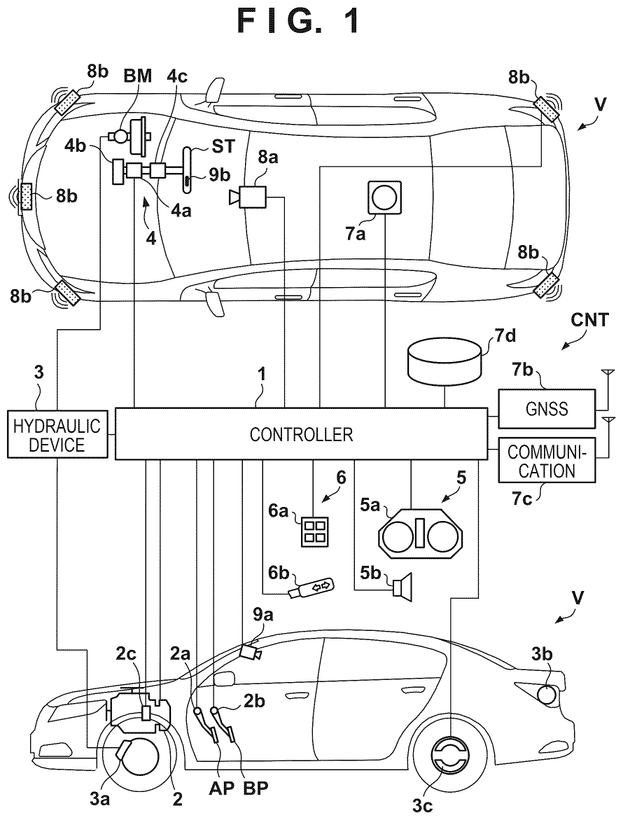

FIG. 1 is a block diagram of a control device CNT according to an embodiment of the present invention and also a schematic diagram of a vehicle V which is an application example of the control device CNT. In FIG. 1, an outline of the vehicle Vis illustrated in a plan view and a side view. The vehicle V according to the present embodiment is, for example, a sedan-type four-wheeled passenger vehicle, and may be, for example, a parallel hybrid vehicle. Note that the vehicle Vis not limited to the four-wheeled passenger vehicle, and may be a straddle type vehicle (motorcycle, three-wheeled vehicle) or a large vehicle such as a truck or a bus.

The control device CNT includes a controller 1 which is an electronic circuit that executes control of the vehicle V including driving assistance of the vehicle V. The controller 1 includes a plurality of electronic control units (ECUs). For example, an ECU is provided for each function of the control device CNT. Each ECU includes a processor represented by a central processing unit (CPU), a storage device such as a semiconductor memory, an interface with an external device, and the like. The storage device stores a program to be executed by the processor, data used for processing by the processor, and the like. The interface includes an input/output interface and a communication interface. Each ECU may include a plurality of processors, a plurality of storage devices, and a plurality of interfaces. A program to be stored in the storage device may be stored in the storage device by being installed in the control device CNT using a storage medium such as a CD-ROM.

The controller 1 controls driving (acceleration) of the vehicle V by controlling a power unit (power plant) 2. The power unit 2 is a travel driving unit that outputs driving force for rotating drive wheels of the vehicle V and can include an internal combustion engine, a motor, and an automatic transmission. The motor can be used as a drive source for accelerating the vehicle V and can also be used as a generator at the time of deceleration or the like (regenerative braking).

In the present embodiment, the controller 1 controls the outputs of the internal combustion engine and the motor or switches a gear ratio of the automatic transmission, for example, in response to driver's driving operation detected by an operation detection sensor 2a provided in an accelerator pedal AP and by an operation detection sensor 2b provided in a brake pedal BP and in accordance with a speed of the vehicle V detected by a rotation speed sensor 2c. Note that the rotation speed sensor 2c that detects a rotation speed of an output shaft of the automatic transmission is provided in the automatic transmission as a sensor for detecting a traveling state of the vehicle V. The vehicle speed of the vehicle V can be calculated from a detection result of the rotation speed sensor 2c.

The controller 1 controls braking (deceleration) of the vehicle V by controlling a hydraulic device 3. A driver's braking operation on the brake pedal BP is converted into hydraulic pressure in a brake master cylinder BM and transmitted to the hydraulic device 3. The hydraulic device 3 is an actuator capable of controlling a hydraulic pressure of a hydraulic oil supplied to a brake device 3a (for example, a disc brake device) provided on each of the four wheels on the basis of the hydraulic pressure transmitted from the brake master cylinder BM.

The controller 1 can control braking of the vehicle V by performing drive control of an electromagnetic valve or the like included in the hydraulic device 3. In addition, the controller 1 can also configure an electric servo brake system by controlling the distribution of the braking force by the brake device 3a and the braking force by the regenerative braking of the motor included in the power unit 2. The controller 1 may turn ON a brake lamp 3b at the time of braking.

The controller 1 controls the steering of the vehicle V by controlling an electric power steering device 4. The electric power steering device 4 includes a mechanism for steering front wheels in response to the driver's driving operation (steering operation) on a steering wheel ST. The electric power steering device 4 includes a drive unit 4a that exerts a driving force (may be denoted as steering assist torque) for assisting the steering operation or automatically steering the front wheels of the vehicle V. The drive unit 4a includes a motor as a drive source. In addition, the electric power steering device 4 further includes a steering angle sensor 4b that detects a steering angle, and a torque sensor 4c that detects steering torque (also, referred to as steering load torque, and is distinguished from steering assist torque) applied to the driver.

The controller 1 controls an electric parking brake device 3c provided in each of the rear wheels of the vehicle V. Each electric parking brake device 3c includes a mechanism for locking the corresponding rear wheel. The controller 1 can control locking and unlocking of the rear wheel by the electric parking brake device 3c.

The controller 1 controls an information output device 5 that provides information to the inside of the vehicle. The information output device 5 includes, for example, a display device 5a that notifies the driver of information using an image and/or a voice output device 5b that notifies the driver of information using a voice. Examples of the display device 5a include a display device provided in an instrument panel and a display device provided in the steering wheel ST. In addition, the display device 5a may include a head-up display. The information output device 5 may notify an occupant of information using vibration or light.

The controller 1 receives an instruction input from the occupant (for example, driver) via an input device 6. The input device 6 is disposed at a position operable by the driver, and includes, for example, a switch group 6a for the driver to instruct the vehicle V and/or a blinker lever 6b for operating a direction indicator (blinker).

The controller 1 recognizes and determines a current position and a course (attitude) of the vehicle V. In the present embodiment, the vehicle Vis provided with a gyro sensor 7a, a global navigation satellite system (GNSS) sensor 7b, and a communication device 7c. The gyro sensor 7a detects a rotational motion (yaw rate) of the vehicle V. The GNSS sensor 7b detects a current position of the vehicle V. In addition, the communication device 7c performs wireless communication with a server that provides map information and traffic information, and then acquires such information. In the present embodiment, the controller 1 determines the course of the vehicle V on the basis of detection results of the gyro sensor 7a and the GNSS sensor 7b, sequentially acquires map information regarding the course from the server via the communication device 7c, and stores the map information in a database 7d (storage device). Note that the vehicle V may be provided with another sensor for detecting the state of the vehicle V, such as an acceleration sensor for detecting the acceleration of the vehicle V.

The controller 1 executes the driving assistance of the vehicle V on the basis of detection results of various detection units provided in the vehicle V. The vehicle V includes surrounding detection units 8a and 8b serving as external sensors that detect the outside (surrounding situation) of the vehicle V, and in-vehicle detection units 9a and 9b serving as in-vehicle sensors that detect a situation inside the vehicle (the state of occupants, particularly, the driver). The controller 1 can ascertain the surrounding situation of the vehicle V on the basis of the detection results of the surrounding detection units 8a and 8b, and then execute the driving assistance of the vehicle V according to the surrounding situation. In addition, the controller 1 can determine whether or not the driver is performing a predetermined operation obligation imposed on the driver when executing the driving assistance, on the basis of the detection results of the in-vehicle detection units 9a and 9b.

The surrounding detection unit 8a is an imaging device (hereinafter, may be denoted as a front camera 8a) that captures an image of the front of the vehicle V, and is attached to the vehicle interior side of the windshield at the front portion of the roof of the vehicle V, for example. The controller 1 can extract a contour of a target object or a lane marking (white line and the like) on a road by analyzing the image captured by the front camera 8a.

The surrounding detection unit 8b is a millimeter wave radar (hereinafter, may be denoted as a radar 8b), detects a target object around the vehicle V using radio waves, and detects (measures) a distance to the target object and a direction (azimuth) of the target object with respect to the vehicle V. In the example illustrated in FIG. 1, five radars 8b are provided, one at the center of the front portion of the vehicle V, one at each of the left and right corner portions of the front portion, and one at each of the left and right corner portions of the rear portion.

Note that the surrounding detection unit provided in the vehicle Vis not limited to the above configuration, and the number of cameras and the number of radars may be changed, or a light detection and ranging (LIDAR) for detecting a target object around the vehicle V may be provided.

The in-vehicle detection unit 9a is an imaging device (hereinafter, may be denoted as an in-vehicle camera 9a) that captures an image of the inside of the vehicle, and is attached to the vehicle interior side at the front portion of the roof of the vehicle V, for example. In the present embodiment, the in-vehicle camera 9a is a driver monitor camera that captures an image of the driver (for example, driver's eyes and face). The controller 1 can determine the direction of the line of sight and the face of the driver by analyzing the image (a face image of the driver) captured by the in-vehicle camera 9a.

The in-vehicle detection unit 9b is a grip sensor (hereinafter, may be denoted as a grip sensor 9b) that detects grip of the steering wheel ST by the driver, and is provided in at least a part of the steering wheel ST, for example. Note that as the in-vehicle detection unit, the torque sensor 4c that detects the steering torque of the driver may be used.

### Example of Driving Assistance Control

Examples of the driving assistance of the vehicle V provided to the driver include acceleration/deceleration assistance, lane keeping assistance, and lane change assistance. The acceleration/deceleration assistance corresponds to driving assistance (adaptive cruise control (ACC)) in which the controller 1 automatically controls acceleration/deceleration of the vehicle V within a predetermined speed range by automatically controlling both the power unit 2 and the hydraulic device 3 on the basis of the map information and the detection result of the surrounding detection unit 8. In a case where there is a preceding vehicle, ACC can also be executed to perform acceleration/deceleration of the vehicle V so that the inter-vehicle distance with the preceding vehicle is kept constant. ACC is effective to reduce a burden on the driver in his/her acceleration/deceleration operation (operation on the accelerator pedal AP or the brake pedal BP).

The lane keeping assistance corresponds to driving assistance (lane keeping assist system (LKAS)) in which the controller 1 automatically controls the electric power steering device 4 on the basis of the map information and the detection result of the surrounding detection unit 8 so that the vehicle V keeps running within the lane. LKAS is effective to reduce a burden on the driver in a steering operation (operation on the steering wheel ST) during the straight-ahead running of the vehicle V.

The lane change assistance corresponds to driving assistance (advanced lane change (ALC) or active lane change assist (ALCA)) in which the controller 1 changes the lane on which the vehicle Vis running, to the adjacent lane by automatically controlling the power unit 2, the hydraulic device 3, and the electric power steering device 4 on the basis of the map information and the detection result of the surrounding detection unit 8. ALC corresponds to lane change assistance based on a system request (request from control device), whereas ALCA corresponds to lane change assistance based on an occupant request. Examples of the system request include a case where a navigation system of giving a route guidance of the vehicle V to a destination requests a lane change of the vehicle V. In a case of performing the occupant request, the driver gives an instruction for a lane change by operating the input device (for example, the blinker lever 6b). Both ALC and ALCA are effective to reduce a burden on the driver in the acceleration/deceleration operation or the steering operation on the vehicle V during the lane change.

Note that some other examples of the driving assistance control may include collision cushioning braking, an ABS function, and traction control that assist in avoiding collision with a target object on a road (for example, a pedestrian, another vehicle, or an obstacle) by controlling the hydraulic device 3, and/or control of the orientation of the vehicle V.

### <Driving Assistance>

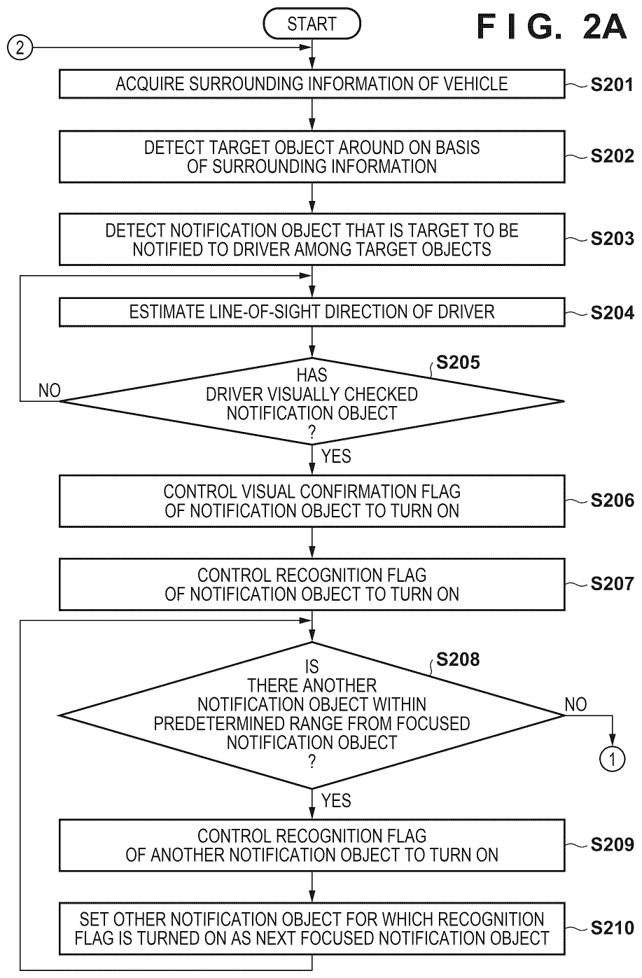

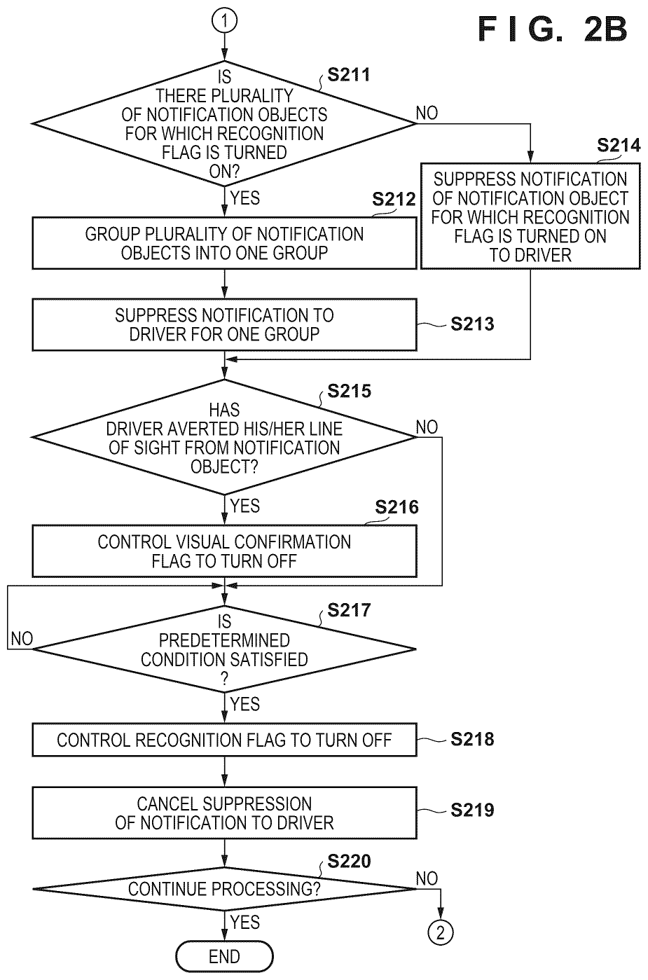

FIGS. 2A and 2B is a flowchart illustrating a processing example of driving assistance control executed by the ECU included in the controller 1. In the present embodiment, the controller 1 operates as a driving assistance device. First, the procedure of the processing of FIGS. 2A and 2B will be described, and then an example will be described with reference to FIG. 3.

In S201, the ECU acquires surrounding information of the vehicle V using the surrounding detection units 8a and 8b serving as external sensors for detecting the outside of the vehicle V (surrounding situation). Note that the surrounding information is continuously acquired at all times.

In S202, the ECU detects a target object present around the vehicle V on the basis of the surrounding information acquired in S201. Here, the target object may include various objects such as a traffic light, a road sign, a preceding vehicle, an adjacent vehicle, a bicycle, a pedestrian, and a running person (runner).

In S203, the ECU detects (specifies) a notification object that is a target to be notified to the driver among the target objects detected in S202. The notification to the driver is a notification for alerting the driver, and can be performed using voice and/or display via the information output device 5. The notification is performed in a case where a notification condition is satisfied. The case where the notification condition is satisfied can be, for example, a case where the notification object suddenly approaches the vehicle V, or a case where a relative position point or trajectory (movement trajectory) with respect to the vehicle V is greatly changed. The notification condition will be described in detail later. The notification object is, for example, a traffic participant present around the vehicle V, and examples thereof include a four-wheeled vehicle, a two-wheeled vehicle, a pedestrian, a bicycle, and a running runner around the vehicle V.

In S204, the ECU estimates the line-of-sight direction of the driver by analyzing the image (face image of the driver) captured by the in-vehicle camera 9a.

In S205, the ECU determines whether or not the driver has visually checked the notification object on the basis of the estimated line-of-sight direction. In a case where a plurality of notification objects has been detected, it is determined whether or not one of the notification objects has been visually checked. In a case where the determination in this step is Yes, the processing proceeds to S206. On the other hand, in a case where the determination in this step is No, the processing returns to S204.

In S206, the ECU controls a visual confirmation flag indicating whether or not the driver has visually checked the notification object, to turn ON. The visual confirmation flag is information in ON or OFF. The notification object for which the visual confirmation flag is turned ON indicates that the driver has visually checked (has viewed) the notification object. The notification object for which the visual confirmation flag is turned OFF indicates that the driver has not visually checked (has not viewed) the notification object.

In S207, the ECU controls a recognition flag indicating whether or not the driver has recognized the notification object, to turn ON. In the present embodiment, in response to the visual confirmation flag being turned ON in S206, the recognition flag of the notification object is also controlled to be turned ON at the same time. However, the present invention is not limited to this example. The recognition flag may be controlled to be turned ON at timing when a predetermined time (for example, 0.4˜0.5 seconds) has elapsed since the visual confirmation flag is turned ON. Even in a case where the driver visually checked (visually checked) the notification object, there is a possibility that there is a time lag in the driver's understanding of what the visually checked object is. That is, a time lag may be provided until the recognition flag is turned ON in consideration of a possibility that it may take a certain time to recognize what the notification object is even when the notification object is visually checked. In S208, the ECU determines whether or not another notification object is present within a predetermined range (predetermined distance range) from the currently focused notification object. When the processing proceeds from S207, the focused notification object is the notification object in which the visual confirmation flag is turned ON (S206) and the recognition flag is turned ON (S207). In a case where the determination in this step is Yes, the processing proceeds to S209. On the other hand, in a case where the determination in this step is No, the processing proceeds to S211.

In S209, the ECU controls the recognition flag of another notification object present within a predetermined range (predetermined distance range) from the focused notification object, to turn ON.

In S210, the ECU sets the other notification object for which the recognition flag is turned ON, as the next focused notification object. Thereafter, the processing returns to S208. In a case where the processing returns from S210, in S208, the other notification object set in S210 becomes the focused notification object.

In S211, the ECU determines whether or not there is a plurality of notification objects for which the recognition flag is turned ON. In a case where the determination in this step is Yes, the processing proceeds to S212. On the other hand, in a case where the determination in this step is No, the processing proceeds to S214.

In S212, the ECU groups the plurality of notification objects for which the recognition flag is turned ON into one group.

In S213, the ECU suppresses notification of the plurality of notification objects, which is included in one group grouped in S212, to the driver.

In a state where the recognition flag is in an ON state, the notification object is captured in the peripheral field of view, or even when the notification object is present outside the peripheral field of view, approximate position and movement of the notification object may still be retained. When the notification is made in such a case, there is a possibility that the notification becomes excessive for the driver. Therefore, in the present embodiment, control is performed to suppress the notification regarding one group for which the recognition flag is turned ON. Suppression of the notification may include prohibition of the notification, reduction of the notification frequency, reduction of the notification volume, making the conditions for issuing the notification stringent, and the like. Making the conditions for issuing the notification stringent may include, for example, increasing a threshold value in a case where the notification is issued in a case where an approaching speed when the notification object suddenly approaches the vehicle Vis a threshold value or more.

In S214, the ECU suppresses the notification of the notification object for which the recognition flag is turned ON (the notification object for which the recognition flag is turned ON in S207), to the driver. Here, only regarding one notification object for which the recognition flag is turned ON, the notification to the driver is suppressed.

In S215, the ECU determines whether or not the driver has averted his/her line of sight from the notification object (the notification object for which the visual confirmation flag is turned ON in S206). Note that the line-of-sight direction of the driver is continuously estimated at all times, and it is determined whether or not the driver has averted his/her line of sight from the notification object on the basis of the estimated line-of-sight direction. In a case where the determination in this step is Yes, the processing proceeds to S216. On the other hand, in a case where the determination in this step is No, the processing proceeds to S217.

In S216, the ECU controls the visual confirmation flag of the notification object, for which the visual confirmation flag is turned ON in S206, to turn OFF. That is, the visual confirmation flag is changed from ON to OFF.

In S217, the ECU determines whether or not a predetermined condition is satisfied. The case where the predetermined condition is satisfied can include a case where a predetermined time change and/or a predetermined situation change occur. The case where the predetermined time change occurs may include that a predetermined time (for example, a preset time in a range of several seconds to tens of seconds) has elapsed since the visual confirmation flag is turned OFF in S216. The case where the predetermined situation change occurs may include that the position and/or trajectory of the notification object with respect to the vehicle V is changed beyond an allowable range. In a case where the determination in this step is Yes, the processing proceeds to S218. On the other hand, in a case where the determination in this step is No, the processing waits.

In S218, the ECU controls the recognition flag to turn OFF. That is, the recognition flag is changed from ON to OFF. In a case where the notification objects are grouped, the recognition flags of all the notification objects belonging to the group are changed to OFF. In a case where the notification objects are not grouped, the recognition flag of only the one notification object, for which the recognition flag is turned ON, is changed to OFF.

For example, when a certain time (30 seconds) has elapsed since the driver last visually checked the notification object, the information recognized by the driver becomes outdated. Therefore, the recognition flag may be controlled to be turned OFF in response to the elapse of a predetermined time (for example, 30 seconds) since the visual confirmation flag is turned OFF in S216. In addition, when the position and/or trajectory of the notification object with respect to the vehicle V is changed beyond the allowable range after the driver last visually checked the notification object, the information recognized by the driver becomes outdated. Therefore, after the visual confirmation flag is turned OFF or after the notification is suppressed in S213 or S214, the recognition flag may be controlled to be turned OFF in response to a change in the position and/or trajectory of the notification object beyond the allowable range. At least one of these kinds of processing may be performed.

In S219, the ECU cancels the suppression of notifications to the driver. That is, in a state where the recognition flag is in the OFF state, in a case where the notification condition is satisfied, the notification to the driver is executed. On the other hand, in a state where the recognition flag is in the ON state, even when the notification condition is satisfied, the notification to the driver is suppressed (prohibition, reduction in frequency, making notification conditions stringent, and the like). As a result, while it can be determined that the notification objects around the notification object within the driver's line of sight has been recognized, notification of the surrounding notification objects is also suppressed, and therefore it is possible to suppress excessive notifications.

According to the present embodiment, in a case where notification objects are not grouped, it is possible to suppress excessive notifications regarding one notification object. On the other hand, in a case where notification objects are grouped, it is determined whether or not the driver can collectively recognize the notification objects in one group unit. Therefore, it is possible to suppress a situation in which individual notification objects are frequently notified individually (=excessive notification).

In step S220, the ECU determines whether to continue the processing. For example, the processing may be continued while the driver activates the vehicle V (when the engine is ON or when the power supply of an electric vehicle is ON). In a case where the determination in this step is Yes, the processing returns to S201. On the other hand, in a case where the determination in this step is No, the processing ends.

### Example of Notification Condition

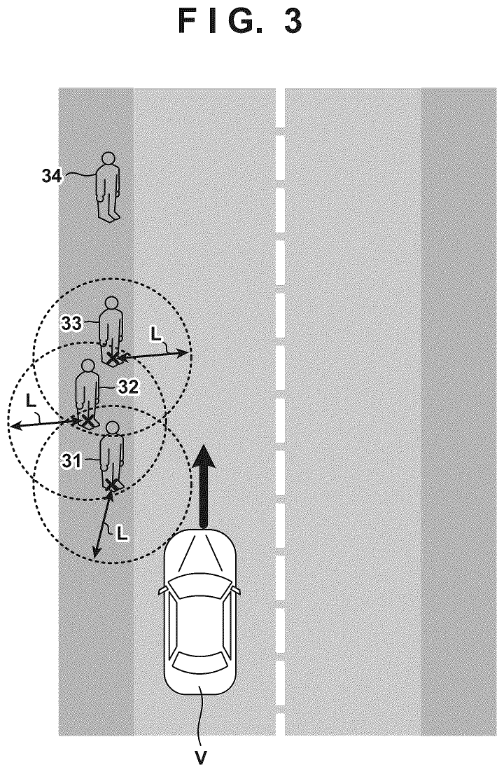

Here, the notification condition may be that an approach of a notification object (for example, a bicycle, a pedestrian, or a runner) to the vehicle Vis detected at the time of right turn and left turn of the vehicle V. For example, the notification condition may be that it is detected that a notification object (for example, a bicycle, a pedestrian, or a runner) is crossing a crosswalk while the vehicle V turns right. FIG. 4 is a diagram illustrating a situation where the vehicle V turns right at an intersection. A notification object 41 is about to cross a crosswalk located in a right-turn direction. In this case, a warning area 43 may be set outside a predetermined area 42 in a traveling direction of the vehicle V, and the notification condition may be satisfied in a case where it is detected that the notification object 41 has entered the warning area 43.

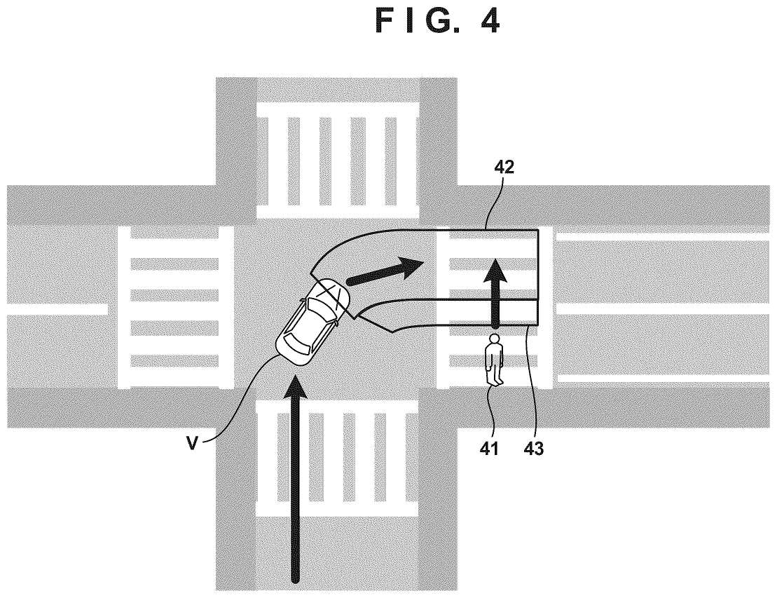

Alternatively, the notification condition may be that Time to Collision (TTC) is equal to or less than a threshold value. That is, the notification may be issued in a case where a value obtained by dividing a distance between the vehicle V and a notification object (for example, a preceding vehicle) present in a predetermined area in the traveling direction of the vehicle by a relative speed between the vehicle and the notification object is equal to or less than a threshold value. FIG. 5 is a diagram illustrating a relationship between the vehicle V and a preceding vehicle traveling in front of the vehicle V. A preceding vehicle 51 is present in a predetermined area 52 in the traveling direction of the vehicle V. In this case, the TTC may be continuously calculated, and the notification condition may be satisfied in a case where the TTC becomes equal to or less than a threshold value. Alternatively, a movement average value of the TTC (the average value of a change in the TTC within a predetermined period) may be constantly calculated, and the notification condition may be satisfied in a case where a second movement average value after a predetermined time (for example, one second) becomes smaller than a first movement average value.

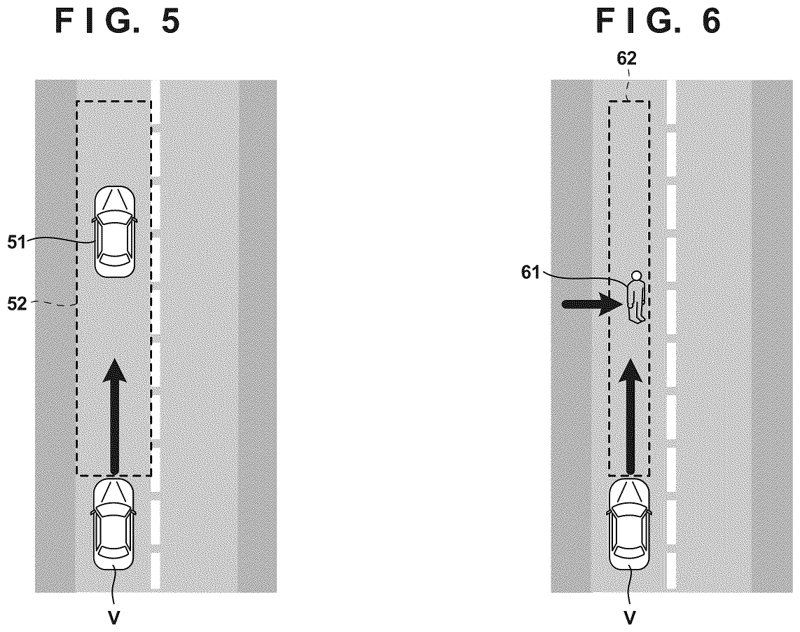

Alternatively, the notification condition may be that the notification object (for example, a bicycle, a pedestrian, or a runner) has entered a predetermined area in the traveling direction of the vehicle V (for example, a predetermined area in front of the vehicle). FIG. 6 is a diagram illustrating a relationship between the vehicle V and a notification object. FIG. 6 illustrates a state in which a notification object has entered a predetermined area 61 in the traveling direction of the vehicle V.

In a case where overlooking occurs in a situation where the driver has not been able to recognize the notification object that needs to be checked again, a notification is issued to the driver for warning.

### Transition Example of Visual Confirmation Flag and Recognition Flag

Next, a specific example of the processing of FIGS. 2A and 2B will be described with reference to FIG. 3. FIG. 3 is a diagram illustrating a case where a plurality of notification objects (pedestrians) is present diagonally in front to the left of the vehicle V. First, it is assumed that the driver of the vehicle V has visually checked a notification object 31. Notification objects 31 to 34 are present on the sidewalk. Each of the notification objects 31 to 34 has a visual confirmation flag and a recognition flag, and the initial state of the flag is an OFF state.

In such a situation, in a case where the driver has visually checked the notification object 31 in S205, the visual confirmation flag and the recognition flag of the notification object 31 are changed to ON in S206 and S207. In S208, it is determined whether or not a notification object is present within a predetermined range (within a range of a circle with a predetermined radius; within a range of a circle with a radius L in the illustrated example) from the notification object 31 that is the focused notification object. Here, since the notification object 32 is present, the determination is Yes, and the processing proceeds to S209. In step S209, the recognition flag of the notification object 32 is changed to ON. At this time, since the driver is not looking at the notification object 32, the visual confirmation flag of the notification object 32 remains OFF. In S210, the notification object 32 for which the recognition flag is turned ON is set as the next focused notification object.

Thereafter, returning to S208, it is determined whether or not the notification object is present within a predetermined range (within a range of a circle with a radius L) from the notification object 32 that is the focused notification object. Here, since the notification object 33 is present, the determination is Yes, and the processing proceeds to S209. In step S209, the recognition flag of the notification object 33 is changed to ON. At this time, since the driver is not looking at the notification object 33, the visual confirmation flag of the notification object 33 remains OFF. In S210, the notification object 33 for which the recognition flag is turned ON is set as the next focused notification object.

Thereafter, returning to S208 again, it is determined whether or not the notification object is present within a predetermined range (within a range of a circle with a radius L) from the notification object 33 that is the focused notification object. Here, since the notification object 34 is not present within a predetermined range from the notification object 33, the determination is No, and the processing proceeds to S211. In S211, since the recognition flags of the plurality of notification objects 31 to 33 are turned ON, the determination in this step is Yes, and the processing proceeds to S212. In S212, the plurality of notification objects 31 to 33 is grouped as one group. Then, in S213, the notification to the driver regarding the one group is suppressed.

Therefore, while each of the recognition flags of the plurality of notification objects 31 to 33 is turned ON, the notification to the driver regarding the notification objects is suppressed, so that excessive notifications can be suppressed. Note that after the notification suppression is canceled in S219 through the subsequent steps, the notification is actually issued according to the satisfaction of the notification condition.

As described above, according to the present embodiment, in a case where a plurality of notification objects is present around the vehicle, when the notification objects can be recognized as one group, it is possible to suppress the notification regarding the entire one group. In the related art in a case where there are a large number of notification objects, making it difficult for the driver to look at all the notification objects, a large number of notifications are issued, but according to the present embodiment, it is possible to suppress excessive notifications.

### First Modification Example

In the above-described embodiment, as illustrated in FIG. 3, a case where one type of notification object (pedestrian) is detected as all of the plurality of notification objects has been described as an example, but it is not necessarily the case that only one type of notification object is detected. A plurality of types of notification objects may be detected. For example, a pedestrian, a bicycle, a two-wheeled vehicle, and the like can be detected. In the present modification example, a situation in which a plurality of types of notification objects is detected will be described as an example.

### Other Transition Examples of Visual Confirmation Flag and Recognition Flag

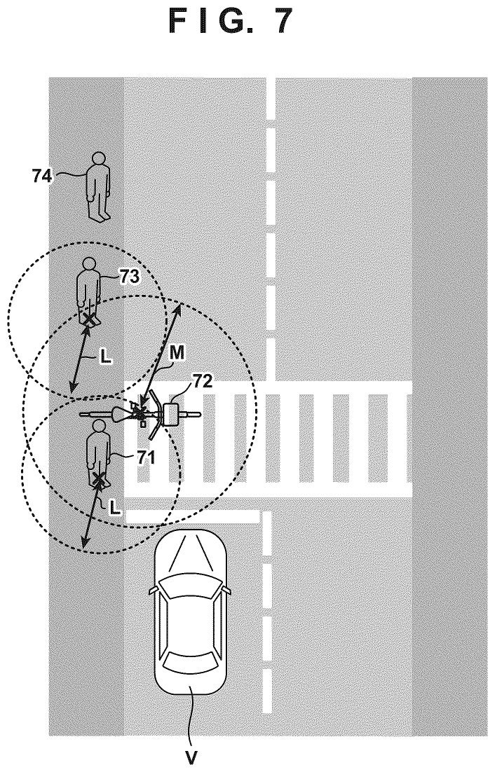

A specific example of the processing of FIGS. 2A and 2B according to the first modification example will be described with reference to FIG. 7. FIG. 7 is a diagram illustrating a case where a plurality of notification objects (pedestrians 71, 73, and 74 and a bicycle 72) is present diagonally in front to the left of the vehicle V. In the present modification example, a plurality of types of notification objects (pedestrian, bicycle) is detected.

First, it is assumed that the driver of the vehicle V has visually checked the notification object 71. The notification objects 71 to 74 are present on the sidewalk. Each of the notification objects 71 to 74 has a visual confirmation flag and a recognition flag, and the initial state of the flag is an OFF state.

In such a situation, when a plurality of notification objects is detected in S203, the type (pedestrian, bicycle, two-wheeled vehicle, four-wheeled vehicle, or the like) of each notification object is determined in advance. Then, in a case where the driver has visually checked the notification object 71 in S205, the visual confirmation flag and the recognition flag of the notification object 71 are changed to ON in S206 and S207. In S208, it is determined whether or not the notification object is present within a predetermined range (within a range of a circle with a radius L) from the notification object 71 that is the focused notification object. Here, since the notification object 72 is present, the determination is Yes, and the processing proceeds to S209. In step S209, the recognition flag of the notification object 72 is changed to ON. At this time, since the driver is not looking at the notification object 72, the visual confirmation flag of the notification object 72 remains OFF. In S210, the notification object 72 for which the recognition flag is turned ON is set as the next focused notification object.

Thereafter, returning to S208, it is determined whether or not the notification object is present within a predetermined range (within a range of a circle with a radius M) from the notification object 72 that is the focused notification object. Since the notification object 72 is a bicycle, the predetermined range is defined by a circle with a radius M (for example, M<N) different from the circle with the radius L in the case of a pedestrian. That is, circles with different radii depending on the types of the notification objects are determined in advance as the predetermined ranges.

Since the notification object 73 is present within a predetermined range (within a range of a circle with a radius M) from the notification object 72, the determination in S208 is Yes, and the processing proceeds to S209. In step S209, the recognition flag of the notification object 73 is changed to ON. At this time, since the driver is not looking at the notification object 73, the visual confirmation flag of the notification object 73 remains OFF. In S210, the notification object 73 for which the recognition flag is turned ON is set as the next focused notification object.

Thereafter, returning to S208, it is determined whether or not the notification object is present within a predetermined range (within a range of a circle with a radius L) from the notification object 73 (pedestrian) that is the focused notification object. Here, the notification object 74 (pedestrian) is present in the vicinity, but is positioned farther than the distance L from the notification object 73. Therefore, the determination is No in S208, and the processing proceeds to S211.

In S211, since the recognition flags of the plurality of notification objects 71 to 73 are turned ON, the determination in this step is Yes, and the processing proceeds to S212. In S212, the plurality of notification objects 71 to 73 is grouped as one group. Then, in S213, the notification to the driver regarding the one group is suppressed.

Therefore, while each of the recognition flags of the plurality of notification objects 71 to 73 is turned ON, the notification to the driver regarding the notification objects is suppressed, so that excessive notifications can be suppressed. Note that after the notification suppression is canceled in S219 through the subsequent steps, the notification is actually issued according to the satisfaction of the notification condition.

As described above, according to the present modification example, it is possible to appropriately group a plurality of types of notification objects and suppress the notification regarding one group. Therefore, occurrence of excessive notifications can be suppressed.

### Second Modification Example

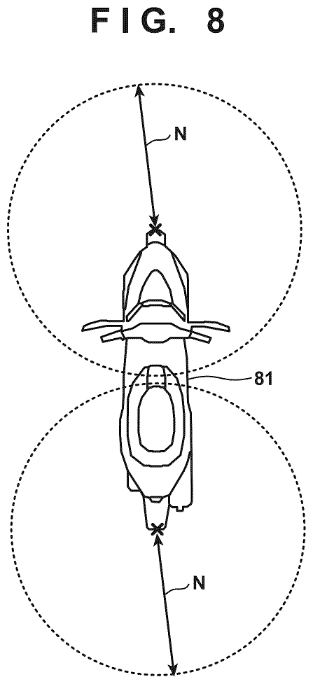

In the above-described embodiment, an example of a pedestrian and a bicycle has been described as a plurality of types of notification objects with reference to FIG. 7, but a two-wheeled vehicle or the like is also assumed as another type of notification object. FIG. 8 is a diagram illustrating an example of a predetermined range in a case where the notification object is a two-wheeled vehicle. The predetermined range in the case of the two-wheeled vehicle may be within a range of two circles of a circle with a radius N about the front end of a two-wheeled vehicle 81 and a circle with a radius N about the rear end of the two-wheeled vehicle 81.

In addition, in the above-described embodiment, the radius L defining the predetermined range in a case where the notification object is a pedestrian, the radius M defining the predetermined range in a case where the notification object is a bicycle, and the radius N defining the predetermined range in a case where the notification object is a two-wheeled vehicle are described. Here, as an example, L=1.4 m, M=1.5 m, and N=1.5 m can be set.

### Third Modification Example

In the above-described embodiment, an example has been described in which the predetermined range is a circle in a case of determining another notification object within the predetermined range from the notification object, but the present invention is not limited to this example. For example, the grouping may be performed by determining whether or not the notification object present in the direction along the traveling direction of the vehicle Vis within a predetermined distance range. That is, in FIGS. 3 and 7, only regarding the notification objects distributed in the direction along the traveling direction of vehicle V (the direction in which the sidewalk extends), whether or not the notification object is within the predetermined distance range may be determined. Then, for the focused notification object, control may be performed such that the notification objects present in a direction intersecting the direction along the traveling direction of the vehicle V (direction in which the sidewalk extends) and in a direction far from the vehicle V are not grouped.

### Other Transition Examples of Visual Confirmation Flag and Recognition Flag

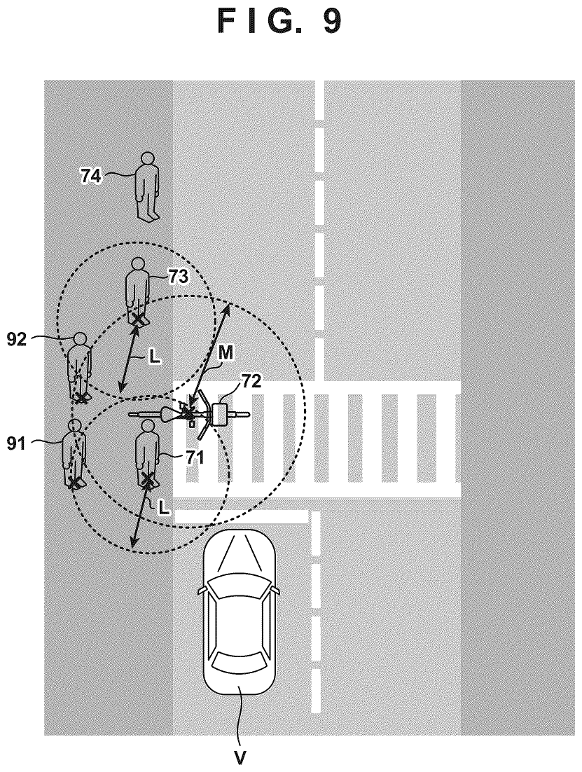

A specific example of the processing of FIGS. 2A and 2B according to the third modification example will be described with reference to FIG. 9. FIG. 9 is a diagram illustrating a case where a plurality of notification objects (pedestrians 71, 73, 74, 91, and 92 and a bicycle 72) is present diagonally in front to the left of the vehicle V. The pedestrian 91 is a notification object present in the direction intersecting the direction along the traveling direction of the vehicle V (direction in which the sidewalk extends) and in the direction far from the vehicle V, with respect to the pedestrian 71. In addition, the pedestrian 92 is a notification object present in the direction intersecting the direction along the traveling direction of the vehicle V (direction in which the sidewalk extends) and in the direction far from the vehicle V, with respect to the bicycle 72.

First, it is assumed that the driver of the vehicle V has visually checked the notification object 71. The notification objects 71 to 74, 91, and 92 are present on the sidewalk. Each of the notification objects 71 to 74, 91, and 92 has a visual confirmation flag and a recognition flag, and the initial state of the flag is an OFF state.

In such a situation, when a plurality of notification objects is detected in S203, the type (pedestrian, bicycle, two-wheeled vehicle, four-wheeled vehicle, or the like) of each notification object is determined in advance. Then, in a case where the driver has visually checked the notification object 71 in S205, the visual confirmation flag and the recognition flag of the notification object 71 are changed to ON in S206 and S207. In S208, it is determined whether or not the notification object is present within a predetermined range (within a range of a circle with a radius L) from the notification object 71 that is the focused notification object. Here, since the notification object 72 and the notification object 91 are present, the determination is Yes, and the processing proceeds to S209. In step S209, the recognition flag of the notification object 72 is changed to ON.

However, since the notification object 91 is a notification object present in the direction intersecting the direction along the traveling direction of the vehicle V (direction in which the sidewalk extends) and in the direction far from the vehicle V, with respect to the notification object 71, the recognition flag of the notification object 91 remains OFF. More specifically, in a case where an angle formed by the direction along the traveling direction of the vehicle V (the direction in which the sidewalk extends) and the direction from the notification object 71 to the notification object 91 is equal to or greater than a first predetermined value (for example, 45 degrees) and is equal to or less than a second predetermined value (135 degrees), and the notification object 91 is present in a direction farther from the vehicle V (farther side of the sidewalk with respect to the roadway) than the notification object 71, the recognition flag of the notification object 91 remains OFF.

At this time, since the driver is not looking at the notification objects 72 and 91, the visual confirmation flags of the notification objects 72 and 91 remain OFF. In S210, the notification object 72 for which the recognition flag is turned ON is set as the next focused notification object.

Thereafter, returning to S208, it is determined whether or not the notification object is present within a predetermined range (within a range of a circle with a radius M) from the notification object 72 that is the focused notification object. Since the notification object 72 is a bicycle, the predetermined range is defined by a circle with a radius M (for example, M<N) different from the circle with the radius L in the case of a pedestrian.

Since the notification objects 73 and 92 are present within a predetermined range (within a range of a circle with a radius M) from the notification object 72, the determination in S208 is Yes, and the processing proceeds to S209. In step S209, the recognition flag of the notification object 73 is changed to ON. However, since the notification object 92 is a notification object present in the direction intersecting the direction along the traveling direction of the vehicle V (direction in which the sidewalk extends) and in the direction far from the vehicle V, with respect to the notification object 72, the recognition flag of the notification object 92 remains OFF. More specifically, in a case where an angle formed by the direction along the traveling direction of the vehicle V (the direction in which the sidewalk extends) and the direction from the notification object 72 to the notification object 92 is equal to or greater than the first predetermined value (for example, 45 degrees) and is equal to or less than the second predetermined value (135 degrees), and the notification object 92 is present in the direction farther from the vehicle V (farther side of the sidewalk with respect to the roadway) than the notification object 72, the recognition flag of the notification object 92 remains OFF.

At this time, since the driver is not looking at the notification objects 73 and 92, the visual confirmation flags of the notification objects 73 and 92 remain OFF. In S210, the notification object 73 for which the recognition flag is turned ON is set as the next focused notification object.

Thereafter, returning to S208, it is determined whether or not the notification object is present within a predetermined range (within a range of a circle with a radius L) from the notification object 73 (pedestrian) that is the focused notification object. Here, the notification object 74 (pedestrian) is present in the vicinity, but is positioned farther than the distance L from the notification object 73. Therefore, the determination is No in S208, and the processing proceeds to S211.

In S211, since the recognition flags of the plurality of notification objects 71 to 73 are turned ON, the determination in this step is Yes, and the processing proceeds to S212. In S212, the plurality of notification objects 71 to 73 is grouped as one group. Then, in S213, the notification to the driver regarding the one group is suppressed.

Therefore, while each of the recognition flags of the plurality of notification objects 71 to 73 is turned ON, the notification to the driver regarding the notification objects is suppressed, so that excessive notifications can be suppressed. Note that after the notification suppression is canceled in S219 through the subsequent steps, the notification is actually issued according to the satisfaction of the notification condition.

As described above, according to the present modification example, for the focused notification object, the recognition flags of the notification objects present in the direction intersecting the direction along the traveling direction of the vehicle V (direction in which the sidewalk extends) and in the direction far from the vehicle V are not turned ON, and the notification objects are not grouped as one group. Since the notification object positioned on the far side far from the vehicle, which has a low necessity of recognition, can be excluded, efficient processing can be realized.

### Fourth Modification Example

In the above-described embodiment, the processing of grouping a plurality of notification objects as one group has been described, but the present invention is not limited to this example. For example, in a case where a plurality of notification objects is moving at different speeds, only notification objects having relative speeds equal to or less than a threshold value may be grouped, and the recognition flag may be turned ON.

For example, a case is considered in which pedestrians as notification objects collectively are walking on the sidewalk along the traveling direction of the vehicle V, and a plurality of bicycles collectively is traveling on the roadway along the traveling direction of the traveling vehicle V near the pedestrians. It is assumed that the relative speed between the pedestrians becomes equal to or less than the threshold value, the relative speed between the bicycles becomes equal to or less than the threshold value, and the relative speed between the pedestrian and the bicycle exceeds the threshold value.

In this case, in a case where the focused notification object is a pedestrian, even when a bicycle is present within a predetermined range from the focused notification object, control is performed such that the pedestrian and the bicycle are not grouped. Pedestrians may be grouped and bicycles may be grouped. However, pedestrians and bicycles are not grouped. As a result, in a situation where a group of pedestrians and a group of bicycles should be distinguished and recognized by the driver, it is possible to prevent erroneous processing where the group of pedestrians and the group of bicycles are collectively recognized by the driver as one group.

In the above-described embodiment, an example of determining whether or not the driver has visually checked the notification object (traffic participant) has been described, but the present invention is not limited to this example. For example, the surrounding environment may be visually checked and recognized through a monitor (display) without being directly and visually checked. In this case, it may be determined whether or not the notification object appearing on the monitor (display) has been visually checked on the basis of the detected line-of-sight direction, and ON/OFF of the visual confirmation flag may be controlled.

### Summary of Embodiments

1. The driving assistance device (1) according to the above embodiments is a driving assistance device comprising:
   a detection unit (1, 8a, 8b) configured to detect a plurality of notification objects as targets for a notification to a driver of a vehicle (V) on the basis of surrounding information of the vehicle;
   an estimation unit (1, 9a) configured to estimate a line-of-sight direction of the driver;
   a first control unit (1) configured to control a first visual confirmation flag to turn ON in a case where the driver has visually checked a first notification object among the plurality of notification objects on the basis of the line-of-sight direction, the first visual confirmation flag indicating whether or not the driver has visually checked the first notification object;
   a second control unit (1) configured to control a first recognition flag to turn ON in a case where the first visual confirmation flag is turned ON, the first recognition flag indicating whether or not the driver has recognized the first notification object;
   a third control unit (1) configured to control a second recognition flag to turn ON in response to the first recognition flag being turned ON in a case where a second notification object among the plurality of notification objects is within a predetermined range from the first notification object, the second recognition flag indicating whether or not the driver has recognized the second notification object;
   a grouping unit (1) configured to group the first notification object and the second notification object, for each of which the recognition flag is turned ON, as one group; and
   a suppression unit (1) configured to suppress the notification regarding the one group.

As a result, it is possible to suppress excessive notifications regarding the notification object recognized by the driver.
2. In the driving assistance device (1) according to the above embodiments, the third control unit controls the second recognition flag to turn ON, and controls a second visual confirmation flag to turn OFF, the second visual confirmation flag indicating whether or not the driver has visually checked the second notification object.

As a result, it is possible to suppress excessive notifications regarding the notification object recognized by the driver even when the driver does not directly look at the notification object.
3. The driving assistance device (1) according to the above embodiments, further comprising:
   a fourth control unit (1) configured to control each recognition flag of the first notification object and the second notification object to turn OFF in a case where a predetermined condition is satisfied; and
   a cancellation unit configured to cancel the suppression of the notification along with cancellation of the grouping in a case where each recognition flag is turned OFF.

As a result, the notification is appropriately issued in a situation where the notification is necessary.
4. In the driving assistance device (1) according to the above
   embodiments, the first control unit controls the first visual confirmation flag to turn OFF in a case where the driver has averted his/her line of sight from the first notification object, and
   the case where the predetermined condition is satisfied includes a case where a first predetermined time has elapsed since the first visual confirmation flag is controlled to be turned OFF.

As a result, since the recognition flag is maintained in the ON state until a predetermined time elapses since the last time the notification object is viewed (while the memory is fresh), it is possible to suppress excessive notifications during this period.
5. In the driving assistance device (1) according to the above embodiments, the case where the predetermined condition is satisfied includes a case where at least one of a position and a trajectory of at least one of the first notification object and the second notification object that are grouped is changed beyond an allowable range.

As a result, the recognition flag is maintained in the ON state until the notification object recognized by the driver is greatly changed and the deviation from the recognition becomes large, so that it is possible to suppress excessive notifications during this period.
6. In the driving assistance device (1) according to the above embodiments, the second control unit controls the first recognition flag to turn ON after a second predetermined time has elapsed since the first visual confirmation flag is turned ON.

As a result, it is possible to realize control in consideration of a time lag from when the driver visually checks the notification object to when the driver recognizes what the notification object is.
7. The driving assistance device (1) according to the above embodiments, further comprising
   a notification unit (5) that issues a notification to the driver,
   wherein the notification unit issues the notification in a case where a notification condition is satisfied.

As a result, it is possible to appropriately alert the driver.
8. In the driving assistance device (1) according to the above embodiments, the case where the notification condition is satisfied includes a case where at least one of the first notification object and the second notification object that are grouped has entered a predetermined area in a traveling direction of the vehicle.

As a result, it is possible to appropriately alert the driver to sudden intrusions into where the vehicle is going to travel or the like.
9. In the driving assistance device (1) according to the above embodiments, the case where the notification condition is satisfied includes a case where a value obtained by dividing a distance between the vehicle and a notification object, which is present in a predetermined area in a traveling direction of the vehicle among the first notification object and the second notification object that are grouped, by a relative speed between the vehicle and the notification object is equal to or less than a threshold value.

As a result, in a case where the TTC becomes equal to or less than the threshold value, it is possible to appropriately alert the driver.
10. In the driving assistance device (1) according to the above embodiments, the suppression unit prohibits the notification while each recognition flag of the first notification object and the second notification object that are grouped is turned ON.

As a result, unnecessary notifications can be prevented.
11. In the driving assistance device (1) according to the above embodiments, the suppression unit reduces frequency of the notification while each recognition flag of the first notification object and the second notification object that are grouped is turned ON, as compared to a case where each recognition flag of the first notification object and the second notification object that are grouped is turned OFF.

As a result, unnecessary notifications can be suppressed.
12. In the driving assistance device (1) according to the above embodiments, the suppression unit makes the notification condition stringent such that the notification condition is less likely to be satisfied while each recognition flag of the first notification object and the second notification object that are grouped is turned ON, as compared to a case where each recognition flag of the first notification object and the second notification object that are grouped is turned OFF.

As a result, unnecessary notifications can be suppressed.
13. The driving assistance device (1) according to the above embodiments, further comprising
   a fifth control unit configured to control a third recognition flag to turn ON in response to the second recognition flag being turned ON in a case where a third notification object among the plurality of notification objects is within a predetermined range from the second notification object, the third recognition flag indicating whether or not the driver has recognized the third notification object,
   wherein the grouping unit groups the first notification object, the second notification object, and the third notification object, for each of which the recognition flag is turned ON, as one group.

As a result, it is possible to suppress excessive notifications regarding the notification object recognized by the driver even when the driver does not directly look at the notification object.
14. In the driving assistance device (1) according to the above embodiments, the fifth control unit controls the third recognition flag to turn ON, and controls a third visual confirmation flag to turn OFF, the third visual confirmation flag indicating whether or not the driver has visually checked the third notification object.

As a result, it is possible to suppress excessive notifications regarding the notification object recognized by the driver even when the driver does not directly look at the notification object.
15. In the driving assistance device (1) according to the above embodiments, the predetermined range is a range set in advance according to a type of a notification object.

As a result, it is possible to perform appropriate grouping according to the type of the notification object, and it is possible to realize suppression of notifications regarding an appropriate target.
16. In the driving assistance device (1) according to the above embodiments, the predetermined range is a circle with a predetermined radius.

As a result, it is possible to suppress the notification assuming that the driver has recognized the notification object within the range of the predetermined distance from the focused notification object.
17. The driving assistance device (1) according to the above embodiments is a driving assistance device comprising:
   a detection unit configured to detect a plurality of notification objects as targets for a notification to a driver of a vehicle (V) on the basis of surrounding information of the vehicle;
   an estimation unit configured to estimate a line-of-sight direction of the driver;
   a grouping unit configured to group a first notification object and one or more second notification objects within a predetermined range from the first notification object, as one group in a case where the driver has visually checked the first notification object among the plurality of notification objects on the basis of the line-of-sight direction; and
   a suppression unit configured to suppress the notification regarding the one group.

As a result, it is possible to suppress excessive notifications regarding the notification object that is considered to be recognized by the driver.
18. The vehicle according to the above embodiments is a vehicle comprising the driving assistance device according to the above embodiments.

As a result, it is possible to realize the function of the driving assistance device according to the above embodiment on the vehicle.
19. The control method for a driving assistance device (1) according to the above embodiments is a control method for a driving assistance device, the control method comprising:
   a detection step (S201-S203) of detecting a plurality of notification objects as targets for a notification to a driver of a vehicle on the basis of surrounding information of the vehicle;
   an estimation step (S204) of estimating a line-of-sight direction of the driver;
   a first control step (Yes in S205, S206) of controlling a first visual confirmation flag to turn ON in a case where the driver has visually checked a first notification object among the plurality of notification objects on the basis of the line-of-sight direction, the first visual confirmation flag indicating whether or not the driver has visually checked the first notification object;
   a second control step (S207) of controlling a first recognition flag to turn ON in a case where the first visual confirmation flag is turned ON, the first recognition flag indicating whether or not the driver has recognized the first notification object;
   a third control step (S208-S209) of controlling a second recognition flag to turn ON in response to the first recognition flag being turned ON in a case where a second notification object among the plurality of notification objects is within a predetermined range from the first notification object, the second recognition flag indicating whether or not the driver has recognized the second notification object;
   a grouping step (S212) of grouping the first notification object and the second notification object, for each of which the recognition flag is turned ON, as one group; and
   a suppression step (S213) of suppressing the notification regarding the one group.

As a result, it is possible to suppress excessive notifications regarding the notification object recognized by the driver.
20. The control method for a driving assistance device (1) according to the above embodiments is a control method for a driving assistance device, the control method comprising:
   a detection step of detecting a plurality of notification objects as targets for a notification to a driver of a vehicle on the basis of surrounding information of the vehicle;
   an estimation step of estimating a line-of-sight direction of the driver;
   a grouping step of grouping a first notification object and one or more second notification objects within a predetermined range from the first notification object, as one group in a case where the driver has visually checked the first notification object among the plurality of notification objects on the basis of the line-of-sight direction; and
   a suppression step of suppressing the notification regarding the one group.

As a result, it is possible to suppress excessive notifications regarding the notification object that is considered to be recognized by the driver.
21. The program according to the above embodiments is a program for causing a computer to execute the control method for a driving assistance device according to the above embodiments.

As a result, it is possible to realize the processing of the driving assistance device by a computer.
22. The storage medium according to the above embodiments is a storage medium storing a program for causing a computer to execute the control method for a driving assistance device according to the above embodiments.

As a result, it is possible to realize the processing of the driving assistance device by the storage medium.

According to the present invention, it is possible to suppress excessive notifications to the driver.

### OTHER EMBODIMENTS

In addition, a program for achieving one or more functions that have been described in each of the embodiments is supplied to a system or an apparatus through a network or via a storage medium, and one or more processors on a computer of the system or the apparatus are capable of reading and executing the program. The present invention is also achievable in such an aspect.

The invention is not limited to the foregoing embodiments, and various variations/changes are possible within the spirit of the invention.

What is claimed is:

1. A driving assistance device comprising:
a detection unit configured to detect a plurality of notification objects as targets for a notification to a driver of a vehicle on the basis of surrounding information of the vehicle;
an estimation unit configured to estimate a line-of-sight direction of the driver;
a first control unit configured to control a first visual confirmation flag to turn ON in a case where the driver has visually checked a first notification object among the plurality of notification objects on the basis of the line-of-sight direction, the first visual confirmation flag indicating whether or not the driver has visually checked the first notification object;
a second control unit configured to control a first recognition flag to turn ON in a case where the first visual confirmation flag is turned ON, the first recognition flag indicating whether or not the driver has recognized the first notification object;
a third control unit configured to control a second recognition flag to turn ON in response to the first recognition flag being turned ON in a case where a second notification object among the plurality of notification objects is within a predetermined range from the first notification object, the second recognition flag indicating whether or not the driver has recognized the second notification object;
a grouping unit configured to group the first notification object and the second notification object, for each of which the recognition flag is turned ON, as one group; and
a suppression unit configured to suppress the notification regarding the one group.

2. The driving assistance device according to claim 1, wherein the third control unit controls the second recognition flag to turn ON, and controls a second visual confirmation flag to turn OFF, the second visual confirmation flag indicating whether or not the driver has visually checked the second notification object.

3. The driving assistance device according to claim 1, further comprising:
a fourth control unit configured to control each recognition flag of the first notification object and the second notification object to turn OFF in a case where a predetermined condition is satisfied; and
a cancellation unit configured to cancel the suppression of the notification along with cancellation of the grouping in a case where each recognition flag is turned OFF.

4. The driving assistance device according to claim 3,
wherein the first control unit controls the first visual confirmation flag to turn OFF in a case where the driver has averted his/her line of sight from the first notification object, and
the case where the predetermined condition is satisfied includes a case where a first predetermined time has elapsed since the first visual confirmation flag is controlled to be turned OFF.

5. The driving assistance device according to claim 3, wherein the case where the predetermined condition is satisfied includes a case where at least one of a position and a trajectory of at least one of the first notification object and the second notification object that are grouped is changed beyond an allowable range.

6. The driving assistance device according to claim 1, wherein the second control unit controls the first recognition flag to turn ON after a second predetermined time has elapsed since the first visual confirmation flag is turned ON.

7. The driving assistance device according to claim 1, further comprising
a notification unit that issues a notification to the driver,
wherein the notification unit issues the notification in a case where a notification condition is satisfied.

8. The driving assistance device according to claim 7, wherein the case where the notification condition is satisfied includes a case where at least one of the first notification object and the second notification object that are grouped has entered a predetermined area in a traveling direction of the vehicle.

9. The driving assistance device according to claim 7, wherein the case where the notification condition is satisfied includes a case where a value obtained by dividing a distance between the vehicle and a notification object, which is present in a predetermined area in a traveling direction of the vehicle among the first notification object and the second notification object that are grouped, by a relative speed between the vehicle and the notification object is equal to or less than a threshold value.

10. The driving assistance device according to claim 1, wherein the suppression unit prohibits the notification while each recognition flag of the first notification object and the second notification object that are grouped is turned ON.

11. The driving assistance device according to claim 1, wherein the suppression unit reduces frequency of the notification while each recognition flag of the first notification object and the second notification object that are grouped is turned ON, as compared to a case where each recognition flag of the first notification object and the second notification object that are grouped is turned OFF.

12. The driving assistance device according to claim 7, wherein the suppression unit makes the notification condition stringent such that the notification condition is less likely to be satisfied while each recognition flag of the first notification object and the second notification object that are grouped is turned ON, as compared to a case where each recognition flag of the first notification object and the second notification object that are grouped is turned OFF.

13. The driving assistance device according to claim 1, further comprising
a fifth control unit configured to control a third recognition flag to turn ON in response to the second recognition flag being turned ON in a case where a third notification object among the plurality of notification objects is within a predetermined range from the second notification object, the third recognition flag indicating whether or not the driver has recognized the third notification object,
wherein the grouping unit groups the first notification object, the second notification object, and the third notification object, for each of which the recognition flag is turned ON, as one group.

14. The driving assistance device according to claim 13, wherein the fifth control unit controls the third recognition flag to turn ON, and controls a third visual confirmation flag to turn OFF, the third visual confirmation flag indicating whether or not the driver has visually checked the third notification object.

15. The driving assistance device according to claim 1, wherein the predetermined range is a range set in advance according to a type of a notification object.

16. The driving assistance device according to claim 1, wherein the predetermined range is a circle with a predetermined radius.

17. A driving assistance device comprising:
a detection unit configured to detect a plurality of notification objects as targets for a notification to a driver of a vehicle on the basis of surrounding information of the vehicle;
an estimation unit configured to estimate a line-of-sight direction of the driver;
a grouping unit configured to group a first notification object and one or more second notification objects within a predetermined range from the first notification object, as one group in a case where the driver has visually checked the first notification object among the plurality of notification objects on the basis of the line-of-sight direction; and
a suppression unit configured to suppress the notification regarding the one group.

18. A vehicle comprising the driving assistance device according to claim 1.

19. A control method for a driving assistance device, the control method comprising:
detecting a plurality of notification objects as targets for a notification to a driver of a vehicle on the basis of surrounding information of the vehicle;
estimating a line-of-sight direction of the driver;
controlling a first visual confirmation flag to turn ON in a case where the driver has visually checked a first notification object among the plurality of notification objects on the basis of the line-of-sight direction, the first visual confirmation flag indicating whether or not the driver has visually checked the first notification object;
controlling a first recognition flag to turn ON in a case where the first visual confirmation flag is turned ON, the first recognition flag indicating whether or not the driver has recognized the first notification object;
controlling a second recognition flag to turn ON in response to the first recognition flag being turned ON in a case where a second notification object among the plurality of notification objects is within a predetermined range from the first notification object, the second recognition flag indicating whether or not the driver has recognized the second notification object;
grouping the first notification object and the second notification object, for each of which the recognition flag is turned ON, as one group; and
suppressing the notification regarding the one group.

20. A control method for a driving assistance device, the control method comprising:
detecting a plurality of notification objects as targets for a notification to a driver of a vehicle on the basis of surrounding information of the vehicle;
estimating a line-of-sight direction of the driver;
grouping a first notification object and one or more second notification objects within a predetermined range from the first notification object, as one group in a case where the driver has visually checked the first notification object among the plurality of notification objects on the basis of the line-of-sight direction; and
suppressing the notification regarding the one group.

21. A non-transitory computer-readable storage medium storing a program for causing a computer to execute the control method for a driving assistance device according to claim 19.

22. A non-transitory computer-readable storage medium storing a program for causing a computer to execute the control method for a driving assistance device according to claim 20.
